(19) United States
(12) Patent Application Publication
(10) Pub. No.: US 2026/0329847 A1
(43) Pub. Date: Oct. 22, 2026

(54) METHOD, DEVICE, AND SYSTEM FOR CONFIRMING DATA STATUS

(71) Applicant: DELL PRODUCTS L.P., ROUND ROCK, TX (US)

(72) Inventors: Yongbing XUE, Shanghai (CN); Mengze LIAO, Shanghai (CN); Weiyang LIU, Shanghai (CN); Ren WANG, Shanghai (CN); Huifeng LI, Shanghai (CN); Qi WANG, Shanghai (CN)

(21) Appl. No.: 19/224,449

(22) Filed: May 30, 2025

(30) Foreign Application Priority Data
Apr. 18, 2025 (CN) 202510495119.9

(51) Int. Cl. G06F 16/23

(52) U.S. Cl. CPC G06F 16/2379

(57) ABSTRACT

A method for confirming data status includes, in response to receiving from a source agent a request for reconciling a data page, storing an identification of the data page. Further, a reconciled status of the data page is acquired based on the identification. The reconciled status is used to confirm whether the data page transmitted in an OTel Log Format has been written to a database. The method further includes, in response to the reconciled status indicating that the data page has not been written to the database for a period of time exceeding a predetermined time length, sending to the source agent an indication for requesting a data collector to retransmit the data page. In this way, the problem that the data collector cannot confirm whether the data page has been written to the database can be solved.

### TECHNICAL FIELD

The present disclosure generally relates to the field of data storage, and more specifically, to a method, device, and system for confirming a data status.

### BACKGROUND

A distributed data collection system is a system based on distributed computing and storage technologies, and is configured to collect data from data sources distributed in different locations, and process, store, and analyze the data. The distributed data collection system, with its high reliability, high scalability, and high performance and flexibility, is widely applied in the Internet of Things data acquisition, log data acquisition, data warehouse construction, real-time data processing (such as network traffic data), and other scenarios.

As an open-source observability framework, OpenTelemetry is a collection of tools, Application Programming Interface (API), and Software Development Kit (SDK), which can be used to detect, generate, collect, and export telemetry data (such as metrics, logs, and traces) to help gain insight into the entire lifecycle of a request in a system, analyze its performance and behavior, and so on.

### SUMMARY OF THE INVENTION

Embodiments of the present disclosure propose a method, device, and system for confirming a data status.

In a first aspect of the embodiments of the present disclosure, a method for confirming a data status is provided. The method includes, in response to receiving from a source agent a request for reconciling a data page, storing an identification of the data page. The method further includes acquiring a reconciled status of the data page based on the identification. The reconciled status is used to confirm whether the data page transmitted in an OTel Log Format has been written to a database. The method further includes, in response to the reconciled status indicating that the data page has not been written to the database for a period of time exceeding a predetermined time length, sending to the source agent an indication for requesting a data collector to retransmit the data page.

In a second aspect of the embodiments of the present disclosure, an electronic device is provided. The electronic device includes one or more processors; and a storage apparatus configured to store one or more programs, where the one or more programs, when executed by the one or more processors, cause the one or more processors to implement a method for confirming a data status. The method includes, in response to receiving from a source agent a request for reconciling a data page, storing an identification of the data page. The method further includes acquiring a reconciled status of the data page based on the identification, where the reconciled status is used to confirm whether the data page transmitted in an OTel Log Format has been written to a database. The method further includes, in response to the reconciled status indicating that the data page has not been written to the database for a period of time exceeding a predetermined time length, sending to the source agent an indication for requesting a data collector to retransmit the data page.

In a third aspect of the embodiments of the present disclosure, a system for confirming a data status is provided, including a data collector, a source agent, and a data status manager. The data collector is arranged in the proximity of a data source and configured to collect a data page from the data source. The source agent is arranged in the proximity of the data collector and configured to send a request for reconciling a data page. The source agent is further configured to, in response to a received reconciled status indicating that the data page has not been written to a database for a period of time exceeding a predetermined time length, request the data collector to retransmit the data page. The data status manager is configured to, in response to receiving from the source agent the request for reconciling the data page, store an identification of the data page. The data status manager is further configured to acquire the reconciled status of the data page based on the identification, where the reconciled status is used to confirm whether the data page transmitted in an OTel Log Format has been written to the database. The data status manager is further configured to, in response to the reconciled status indicating that the data page has not been written to the database for the period of time exceeding the predetermined time length, send to the source agent an indication for requesting the data collector to retransmit the data page.

It should be understood that the content described in the Summary part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above-mentioned and other features, advantages, and aspects of the embodiments of the present disclosure will become more apparent with reference to the accompanying drawings and the following detailed description. In the accompanying drawings, identical or similar reference numerals represent identical or similar elements, in which

FIG. 1 is a schematic diagram of an example environment in which some embodiments of the present disclosure can be implemented;

FIG. 2 is a flowchart of a process for processing a reconciled status according to some embodiments of the present disclosure;

FIG. 3 is a schematic diagram of a system for confirming a data status according to some embodiments of the present disclosure;

FIG. 4 is a flowchart of interaction of a process for confirming a data status according to some embodiments of the present disclosure;

FIG. 5 is a flowchart of a process of determining a predetermined time length according to some embodiments of the present disclosure;

FIG. 6 is a flowchart of a method for confirming a data status according to some embodiments of the present disclosure; and

FIG. 7 is a block diagram of a device according to some embodiments of the present disclosure.

### DETAILED DESCRIPTION

The embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be construed as “at least one embodiment.” The terms “first,” “second,” and the like may refer to different or the same objects. Other explicit and implicit definitions may also be included below.

Modern enterprises rely heavily on data-driven insight, which requires robust data collection systems that collect various types of business data from different sources and reliably transfer it to a central repository.

In related techniques, a lightweight data collector is employed to collect data from a data source page by page in units of data pages. Then, the data is transmitted to an OpenTelemetry pipeline for processing and transferred to a back-end database. The data collector may confirm receipt of the data; however, this confirmation only guarantees delivery to the OpenTelemetry pipeline, but cannot guarantee the persistence of the data in the database. This asynchronous persistence model presents two major challenges: one challenge is the lack of persistence confirmation, which prevents the data collector from confirming whether the data has been successfully persisted into the database; and the other challenge is the difficulty of recovering a particular data page from a collection point if the data is lost during transmission or processing within the OpenTelemetry pipeline. Moreover, the data at the data source dynamically changes and may change over time, and therefore, this exacerbates the challenges of data recovery.

To this end, the embodiments of the present disclosure propose a solution for confirming a data status, and more specifically, a lightweight solution for confirming a data status is introduced for a distributed data collection system to ensure data integrity.

In an embodiment of the present disclosure, when receiving a data page from a data collector, a source agent (e.g., arranged in the proximity of a data collector) sends a request for reconciling the data page to a data status manager. After receiving the request, the data status manager acquires a reconciled status based on information such as an identification of the data page included in the request. The reconciled status is used to confirm whether the data page transmitted in an OTel Log Format has been written to a database. If the reconciled status indicates that a transmission time of the data page exceeds a predetermined time length, that is, the data page has not been written to the database for a period of time exceeding the predetermined time length, the data status manager sends to the source agent an indication for requesting the data collector to retransmit the data page. In this way, the problem that the data collector cannot confirm whether the data page has been written to the database can be solved. When data loss occurs in a transmission channel, this solution can achieve effective retransmission of the data page.

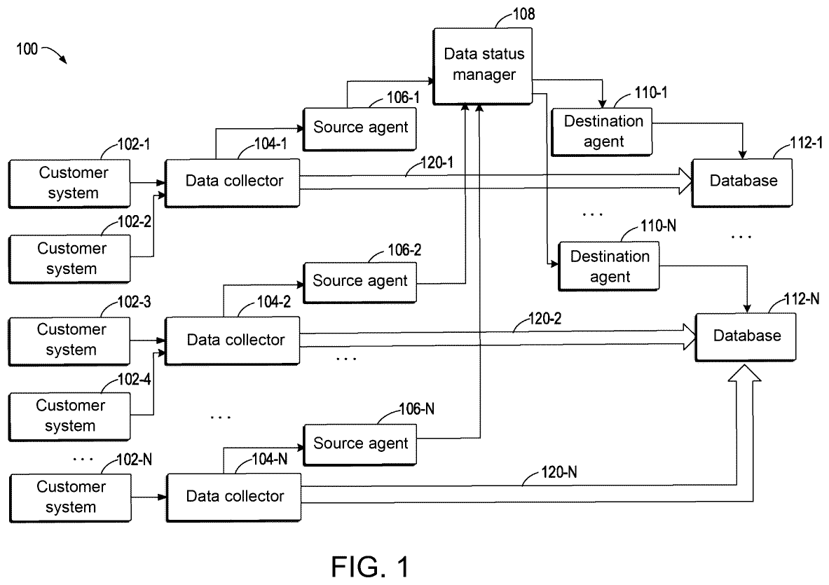

FIG. 1 is a schematic diagram of an example environment 100 in which some embodiments of the present disclosure can be implemented. As shown in FIG. 1, the environment 100 includes a customer system 102, a data collector 104, and a source agent 106 arranged on a data source side. A customer system 102-1, a customer system 102-2, a customer system 102-3, a customer system 102-4, . . . , and a customer system 102-N as shown in FIG. 1 are collectively or individually referred to as the customer system 102; a data collector 104-1, a data collector 104-2, . . . , and a data collector 104-N are collectively or individually referred to as the data collector 104; and a source agent 106-1, a source agent 106-2, . . . , and a source agent 106-N are collectively or individually referred to as the source agent 106.

The customer system 102 (also known as a data source) may be distributed in different geographical areas, which is not limited in the embodiments of the present disclosure. The data collector 104 is arranged in the proximity of the customer system 102 to collect data from one or more customer systems 102 in the vicinity. In some embodiments, the data collector 104 performs data collection in units of data pages. The source agent 106 is arranged in the proximity of the data collector 104. In other words, the source agent 106 and the data collector 104 are all arranged in the proximity of the data source. The source agent 106 acquires, from a nearby data collector 104, a data page it collects, and identifications of the one or more data pages. The source agent 106 may further calculate another identification (for example, a digital fingerprint) of that data page based on these identifications. According to embodiments of the present disclosure, advantages such as reduced network latency and utilization of edge computing are achieved by arranging the data collector 104 and the source agent 106 in the proximity of the customer system 102.

Still referring to FIG. 1, the environment 100 further includes a destination agent 110 and a database 112 arranged on a destination side. A destination agent 110-1, . . . , and a destination agent 110-N as shown in FIG. 1 are collectively or individually referred to as the destination agent 110; and a database 112-1, . . . , and a database 112-N are collectively or individually referred to as the database 112.

In some embodiments, the destination agent 110 may be arranged in the proximity of the database 112. The destination agent 110 communicates with the database 112 in its vicinity over a network, thereby reducing network latency and speeding up computation by bringing the deployment locations of the two closer.

In addition, in the environment 100, the data pages collected by the data collector 104 is transmitted in the OTel Log Format to the database 112 in the background, and transmission channels are as shown by 120-1, 120-2, . . . , and 120-N in FIG. 1. According to an embodiment of the present disclosure, data from different data sources in different geographical locations can be received and output to a plurality of destinations, thereby meeting different needs of a data collection system. At the same time, data may be adjusted to a different format within a transmission channel 120, or may be performed with aggregation before being written to the database.

Still referring to FIG. 1, the environment 100 further includes a data status manager 108 arranged as a central node. The data status manager 108 is communicatively in connection with the source agent 106 and the destination agent 110, respectively, so as to acquire the reconciled status of the data page in time. The reconciled status is used to confirm whether the data page transmitted in the OTel Log Format (i.e., the data page collected by the data collector 104) has been written to the database 112. In some embodiments, the data status manager 108 tends to be arranged in the proximity of the destination side.

In some embodiments, the source agent 106 sends a request for reconciling the data page to the data status manager 108 at regular intervals. The request includes an identification of the data page, and the identification may include, for example, at least one of a data collector identification (noted as Data Collector ID), a data page identification (noted as Data Page ID), a resource type (noted as Resource Type), or a digital fingerprint generated based on the data page (also known as a first digital fingerprint). In some embodiments, the digital fingerprint is generated by calculating an MD5 hash value of the data page. The request may further include a data collection time (noted as Data Collection Time).

After receiving a request from the source agent 106, the data status manager 108 confirms to the destination agent 110 whether the data page to which the identification points exists in the database 112 (that is, whether the data page has been written to the database). The destination agent 110 queries a data page in a nearby database 112 based on the above identification and generates a digital fingerprint (also known as a second digital fingerprint) of the found data page. The digital fingerprint is generated by calculating an MD5 hash value of the found data page. Thereafter, by determining whether the second data fingerprint is consistent with the first digital fingerprint, the destination agent 110 confirms whether the data page has been written into the database 112, and returns the confirmation result (i.e., the reconciled status) to the data status manager 108.

The reconciled status acquired by the data status manager 108 from the destination agent 110 includes that the data page has been written to the database (referred to as “reconciled”) and the data page has not been written to the database (referred to as “unreconciled”). The data status manager 108 performs further processing according to the acquired reconciled status.

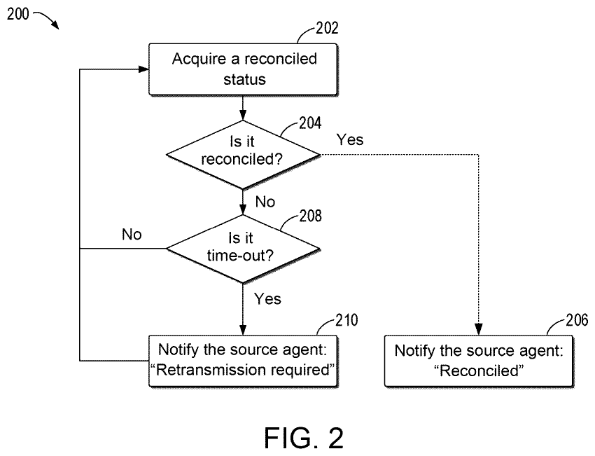

FIG. 2 is a flowchart of a process 200 for processing a reconciled status according to some embodiments of the present disclosure. With reference to FIG. 2, at a block 202, the process 200 acquires a reconciled status. At this point, the reconciled status includes reconciled and unreconciled. If the data page has been written to the database 112, the acquired reconciled status is reconciled, and if the data page has not been written to the database 112, the acquired reconciled status is unreconciled.

At a block 204, the process 200 determines, according to the reconciled status, whether the data page is reconciled. If the data page is reconciled, the process proceeds to a block 206, and the data status manager 108 notifies the source agent 106 that the data page is reconciled. At the same time, the data status manager 108 may also send an indication of deleting the data page. The reconciliation process for the data page ends.

If the data page is not reconciled, the process proceeds to a block 208, and the data status manager 108 needs to further determine whether a transmission time of the data page exceeds a predetermined time length. Specifically, it is determined whether a time period between the current time and the data collection time (that is, a difference between the current time and the data collection time) is greater than the predetermined time length. If the time period is greater than the predetermined time length, it indicates timing out. If the time period is not greater than the predetermined time length, it indicates no timing out.

According to the embodiments of the present disclosure, the predetermined time length can guarantee the efficiency and reliability in the data reconciliation process. If the predetermined time length is set too short, it may trigger an error alert and unnecessary data retransmission, which may cause overload of the resources of the transmission channel. If the predetermined time length is set too long, there is a risk that too much data is stored locally, and a storage capacity limit may be exceeded. In some embodiments, the predetermined time length is dynamically determined based on the identification of the data page. The specific method of determining the predetermined time length will be described in detail below and is not repeated here.

If it is determined that timing out is confirmed, the process proceeds to a block 210, and the data status manager 108 notifies the source agent 106 that “retransmission required,” that is, the data status manager 108 sends to the source agent 106 an indication for requesting the data collector 104 to retransmit the data page. Therefore, the reconciled status further includes, in addition to “reconciled” and “unreconciled,” indicating to the source agent 106 of retransmitting the data page (referred to simply as “retransmission required”) when a data page has not been written to the database for a period of time exceeding the predetermined time length. At this point, in response to the indication “retransmission required,” the source agent 106 requests the data collector 104 to retransmit the data page. After that, the data status manager 108 repeats the above-mentioned process 200 and enters the block 202 until the reconciled status is “reconciled,” and the process 200 ends.

If it is determined that no timing out is confirmed, the process returns to the block 202, the data status manager 108 continues to acquire the reconciled status until the reconciled status is “reconciled,” and the process 200 ends.

According to the solution of the present disclosure, whether data collected by the data collector has been written to the database can be determined. The solution can be deployed in an environment that relies on high throughput data collection from a distributed customer system, can guarantee end-to-end data integrity, and at the same time of verifying data integrity, can minimize the amount of data transmission, thereby improving the efficiency.

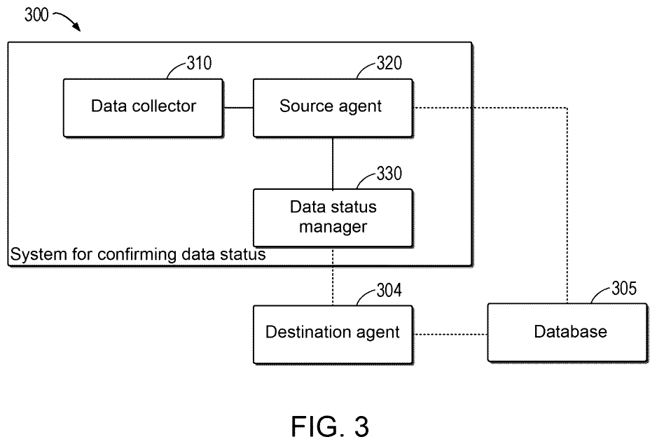

FIG. 3 is a schematic diagram of a storage system 300 according to some embodiments of the present disclosure. Referring to FIG. 3, the storage system 300 includes a system for confirming a data status, a destination agent 304, and a database 305. The system for confirming a data status includes a data collector 310, a source agent 320, and a data status manager 330. In other embodiments, the destination agent 304 may also be deployed within the system for confirming a data status. In summary, the destination agent 304 is arranged in the proximity of the database 305 (for example, it may be a third-party database) of the destination, is communicatively in connection with the database 305, and is responsible for reconciling to the database whether a data page has been written. It should be noted that the components shown in FIG. 3 are schematic and that the present disclosure does not limit quantities of the components within the system 300 accordingly.

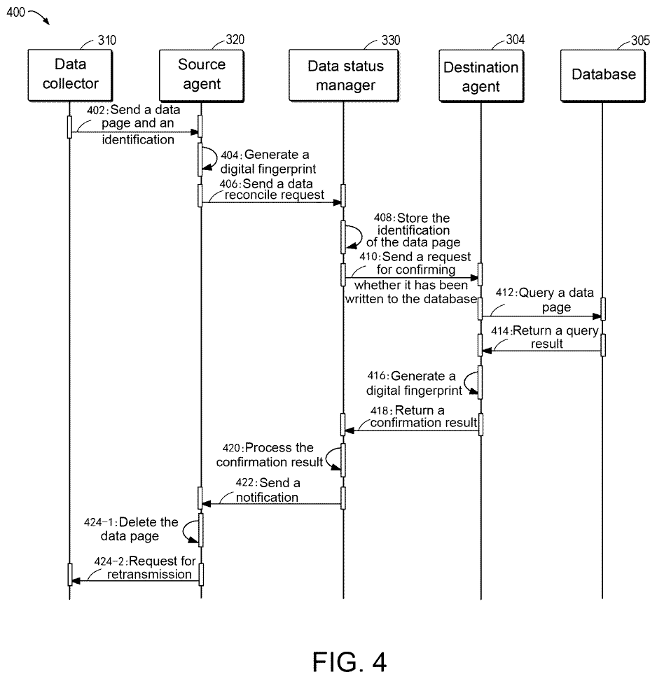

The data collector 310 is arranged in the proximity of a data source and collects a data page from the data source. The source agent 320 is arranged in the proximity of the data collector 310. The data collector 310 and the source agent 320 may be deployed on separate hardware or may be deployed on the same hardware, which is not limited by this embodiment. The data status manager 330, as a central component, is responsible for managing and monitoring data pages. FIG. 4 is a flowchart of interaction of a process 400 for confirming a data status according to some embodiments of the present disclosure. The interaction process of the components within the system 300 is further described below with reference to FIG. 4.

At 402, the data collector 310 sends the collected data page and one or more identifications to the source agent 320. In some embodiments, the data collector 310 transmits the collected data page to the database in an OTel Log Format, and sends information such as a back-up of the data page (hereinafter collectively refer to as a “data page”) and the identification of the data page to the source agent 320. The identification may be, for example, one or more of a data collector identification (a unique identifier for the data collector 310), a data page identification (a unique identifier for the data page), and a resource type (that identifies a resource of the data page). In some embodiments, the data collector 310 may also send a data collection time (a time stamp that the data collector 310 collects the data page from the customer system) to the source agent 320.

At 404, the source agent 320 stores the data page, and the source agent 320 generates a digital fingerprint of the data page. In some embodiments, the digital fingerprint is also used as an identification for identifying each data page.

At 406, the source agent 320 sends to the data status manager 330 a request for reconciling the data page, the request including at least one of the identifications of the data page at 402, the digital fingerprint, or the data collection time. This will trigger the data status manager 330 to start the data reconciliation process.

According to some embodiments, the source agent 320 may periodically (for example, but not limited to, every 1 minute) send to the data status manager 330 a request for reconciling a data page, until a reconciled status indicating that the data page has been written to the database is acquired from the data status manager 330.

At 408, the data status manager 330 stores the identification of the data page. In some embodiments, the data status manager 330 uses a data table to track the reconciled status of the data page. The data table may include the following key elements: data collector identification, data page identification, resource type, data collection time, digital fingerprint, reconciled status, and data reconcile time. The data collector identification, the data page identification, the resource type, the data collection time, and the digital fingerprint, that is, the information carried in the request, are stored in the data table here in an associated manner.

In addition, the data table further includes the reconciled status and the data reconcile time. The reconciled status is used to identify whether the data page has been reconciled or whether retransmission is required in the case of unreconciled. The data reconcile time records a time stamp when the reconciled status of the data page is reconciled.

Table 1 exemplifies a data table in the data status manager. As shown in Table 1, the data table includes 5 data records, one data record representing a data page, and in one data record, one or more identifications of a data page is stored in an associated manner. It should be understood that when the reconciled status of the data page is “unreconciled” or “retransmission required,” the data reconcile time is null (for example, data records 1, 4, and 5).

TABLE 1
Data Table in Data Status Manager

| | Data | | | | | Data | Data |
|---|---|---|---|---|---|---|---|
| | collector | Data page | Resource | First digital | Reconciled | collection | reconcile |
| | identification | identification | type | fingerprint | status | time | time |
| 1 | 3146e1eb- | d6433877- | asset_v2 | 1c94adf27461ad9cc | Unreconciled | 2024 Nov. 30 | |
| | 8ba8-59e4- | b0cc-5a6d | | | | 14:30:00 | |
| 2 | a9a6- | 8346- | | | | | |
| | 53118a63f957 | da2fd1ec3d1c | | | | | |
| 3 | e6174bb1- | 482e3586- | resource_group_v2 | 2c88fj12a4fdj1299 | Reconciled | 2024 Nov. 30 | 2024 Nov. 30 |
| | 8d5e-5ac5- | e690-59a7- | | | | 14:30:00 | 15:30:15 |
| | 984a- | 86f8- | | | | | |
| | 29978f3525de | 8725f14c0e45 | | | | | |
| 4 | 352b61d2- | 177d01d1- | activity_v3 | 1cka1299923919010 | Retransmission | 2024 Nov. 30 | |
| | 9b87-5934- | 09c9-54a2- | | | required | 14:30:00 | |
| | 8195- | ba31- | | | | | |
| | 9a362dbf832b | 3d73bbde5389 | | | | | |
| 5 | 352b61d2- | 177d01d1- | activity_v3 | 1cka1299923919010 | Unreconciled | 2024 Nov. 30 | |
| | 9b87-5934- | 09c9-54a2- | | | | 14:30:00 | |
| | 8195- | ba31- | | | | | |
| | 9a362dbf832b | 3d73bbde5389 | | | | | |

According to the above method, the data table can minimize the data storage requirements and can effectively track and manage the data reconciled status of the whole system.

At 410, the data status manager 330 sends to the destination agent 304 a request for confirming whether a data page has been written to the database. According to the embodiments of the present disclosure, the indication further includes an identification of the corresponding data page. In some embodiments, the indication includes a data page identification and a digital fingerprint. In still other embodiments, the indication includes a data page identification, a digital fingerprint, and a data collector identification.

At 412, the destination agent 304 queries the database 305 for a data page based on the above identification. In some embodiments, the destination agent 304 performs a query in the database 305 base on the data page identification. In still other embodiments, the destination agent 304 performs a query in the database 305 base on the data page identification and the data collection time to optimize the query efficiency. The data collection time is used as a filter condition to query the data page identification after the time.

At 414, the database 305 returns the query result to the destination agent 304. The database 305 may find more than one eligible data page, or may not find any eligible data page. If a data page is found, the found data page is returned to the destination agent 304. If no data page is found, the destination agent 304 is notified that no relevant data is found.

At 416, the destination agent 304 generates a digital fingerprint (that is, a second digital fingerprint) of the found data page. Then, the destination agent 340 determines whether the digital fingerprint is consistent with the digital fingerprint (that is, the first digital fingerprint) stored in the data table. If the two are consistent, it is confirmed that the data page has been written to the database 305. If the two are inconsistent, it is confirmed that the data page has not been written to the database 305. Assuming that the destination agent 304 finds a plurality of data pages, digital fingerprints of the data pages are generated, respectively. After that, whether the digital fingerprints are consistent with the digital fingerprint in the data table is determined respectively, and the corresponding results are confirmed. According to other embodiments, if the destination agent 304 does not find a data page, it is confirmed that the data page has not been written to the database 305.

At 418, the destination agent 304 sends to the data status manager 330 an indication for confirming whether a data page has been written to the database (in other words, returns a confirmation result). As mentioned earlier, the indication represents the reconciled status of the data page. The reconciled status acquired by the data status manager 330 from the destination agent 304 includes that the data page has been written to the database (“reconciled”) and the data page has not been written to the database (“unreconciled”).

At 420, the data status manager 330 performs further processing according to the confirmation result. Then, at 422, a corresponding notification instruction is sent to the source agent 320 according to the processing result.

If the reconciled status is reconciled, in 420, the data status manager 330 determines the current time as the data reconcile time of the data page and stores it in the data table in an associated manner. At the same time, the reconciled status in the update data table is “reconciled.”

At 422, the data status manager 330 notifies the source agent 320 that it has been reconciled. Then, the process proceeds to 424-1, and the source agent 320 deletes the data page. Moreover, the source agent 320 no longer performs 406 periodically.

If the reconciled status is unreconciled, further analysis is required in 420 to determine whether the transmission time of the data page has exceeded a predetermined time length. The transmission time is determined based on a difference between the current time and the data collection time. The predetermined time length needs to be determined based on the identification of the data page.

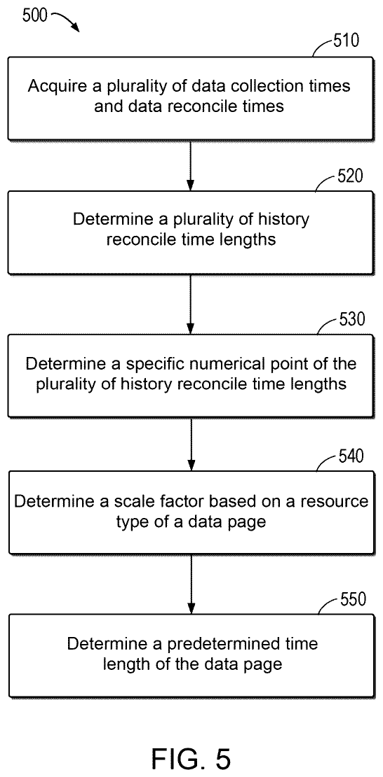

As mentioned above, the efficiency and reliability of data reconciliation can be balanced by setting the predetermined time length. The setting of the predetermined time length is influenced by a number of factors, such as the performance of the transmission channel, network latency, database write speed, geographical distance between the data collector 310 and the database 305, and the like. FIG. 5 is a flowchart of an example process 500 of determining a predetermined time length according to some embodiments of the present disclosure.

As shown in FIG. 5, at a block 510, a plurality of the data collection times and a plurality of data reconcile times in a recent period of time associated with the data collector identification are acquired. In other words, the data collection time and the data reconcile time associated with the data collector identification are looked up from the data table according to the data collector identification. Further, the look-up range is limited to the most recent time (for example, the past hour). It should be noted that the data collection time and the data reconcile time acquired here appear in pair, that is, they are from the same data record in the data table. It should be understood that for the data record acquired, its reconciled status should be “reconciled.” In still other embodiments, the resource type associated with it may also be acquired.

Table 2 illustratively shows 8 data records acquired in the above manner, including the resource type, the data collection time, and the data reconcile time.

TABLE 2
Data Records Associated with Data Collector Identification

| Resource type | Data collection time | Data reconcile time |
|---|---|---|
| asset_v2 | 2024-11-30 14:00:00 | 2024-11-30 14:02:20 |
| resource_group_v2 | 2024-11-30 14:00:00 | 2024-11-30 14:01:50 |
| upgrade_package_v2 | 2024-11-30 14:00:00 | 2024-11-30 14:01:30 |
| license_v2 | 2024-11-30 14:00:00 | 2024-11-30 14:02:31 |
| alert_v2 | 2024-11-30 14:00:00 | 2024-11-30 14:03:15 |
| activity_v3 | 2024-11-30 14:00:00 | 2024-11-30 14:03:50 |
| activity_v3 | 2024-11-30 14:15:00 | 2024-11-30 14:18:30 |
| activity_v3 | 2024-11-30 14:30:00 | 2024-11-30 14:33:31 |

At a block 520, a plurality of history reconcile time lengths are determined correspondingly based on the plurality of data collection times and the plurality of data reconcile times. Specifically, for each pair of data collection time and data reconcile time, a difference between the data reconcile time and the data collection time is used as a corresponding history reconcile time length.

For the data acquired in Table 2, the corresponding history reconcile time length is calculated, as shown in Table 3.

TABLE 3
History Reconcile Time Length

| Resource type | History reconcile time length |
|---|---|
| asset_v2 | 2 minutes and 20 seconds |
| resource_group_v2 | 1 minute and 50 seconds |
| upgrade_package_v2 | 1 minute and 30 seconds |
| license_v2 | 2 minutes and 31 seconds |
| alert_v2 | 3 minutes and 15 seconds |
| activity_v3 | 3 minutes and 50 seconds |
| activity_v3 | 3 minutes and 30 seconds |
| activity_v3 | 3 minutes and 31 seconds |

At a block 530, a specific numerical point of the plurality of history reconcile time lengths is determined. In some embodiments, the specific numerical point is the 90th percentile.

Continuing with the example above, the 90th percentile is calculated for the 8 history reconcile time lengths in Table 3. First, the history reconcile time lengths are sorted: 1:30, 1:50, 2:20, 2:31, 3:15, 3:30, 3:31, 3:50. The 90th percentile is then calculated to be 3:31, that is, 3 minutes and 31 seconds.

At a block 540, a scale factor is determined based on a resource type of a data page. According to the embodiments, different scale factors are set for different resource types in consideration of the timeliness of resources. For the resource type with a strong timeliness, a small scale factor is set; on the contrary, for the resource type with a weak timeliness, a large scale factor is set. In other words, the stronger timeliness the resource type has, the smaller the scale factor. Continuing with the example above, for the resource types in Table 3, corresponding scale factors are set, as shown in Table 4. It should be noted that several resource types, such as asset, resource group, upgrade package, license certificate, alert event, and active event, are shown here as examples, without limiting the resource type. In practical applications, categories of the resource types and values of their scale factors can be determined according to the application scenarios.

TABLE 4

| Scale Factors of Resource Types | |
|---|---|
| Resource type | Scale factor |
| asset_v2 | 1.5 |
| resource_group_v2 | 1.5 |
| upgrade_package_v2 | 1.5 |
| license_v2 | 1.6 |
| alert_v2 | 1.0 |
| activity_v3 | 1.0 |

At a block 550, the predetermined time length of the data page is determined based on the specific numerical point and the scale factor. In some embodiments, a product value of the specific numerical point and the scale factor is used as the predetermined time length of the data page. Continuing the above example, Table 5 shows the final calculated predetermined time length.

TABLE 5
Predetermined Time Lengths of Resource Types

| Resource type | Calculation process | Predetermined time length |
|---|---|---|
| asset_v2 | (3 minutes and 30 seconds) * 1.5 | 5 minutes and 15 seconds |
| resource_ | (3 minutes and 30 seconds) * 1.5 | 5 minutes and 15 seconds |
| group_v2 | | |
| upgrade_ | (3 minutes and 30 seconds) * 1.5 | 5 minutes and 15 seconds |
| package_v2 | | |
| license_v2 | (3 minutes and 30 seconds) * 1.6 | 5 minutes and 36 seconds |
| alert_v2 | (3 minutes and 30 seconds) * 1.0 | 3 minutes and 30 seconds |
| activity_v3 | (3 minutes and 30 seconds) * 1.0 | 3 minutes and 30 seconds |

According to the process 500 of the present disclosure, by considering the history reconcile time length of the data collector where the data page is located, and selecting the specific numerical point therefrom, a typical data reconcile time can be accurately captured and an extreme abnormal value can be effectively excluded in the process of dynamically determining the predetermined time length. Moreover, considering the timeliness of the resources, the scale factors for different resource types are set to further optimize the specific numerical point, which can take into account the efficiency and reliability of data reconciliation.

The process returns to 420, and if it is determined, upon judgment, that the transmission time of the data page exceeds the predetermined time length, then at 422, the data status manager 330 notifies the source agent 320 that a retransmission is required. Then, the process proceeds to 424-2, in which the source agent 320 requests the data collector 310 to retransmit the data page.

If it is determined, upon judgment, that the transmission time of the data page does not exceeds the predetermined time length, the source agent 320 continues to perform 406 to periodically send to the data status manager 330 a request for reconciling the data page.

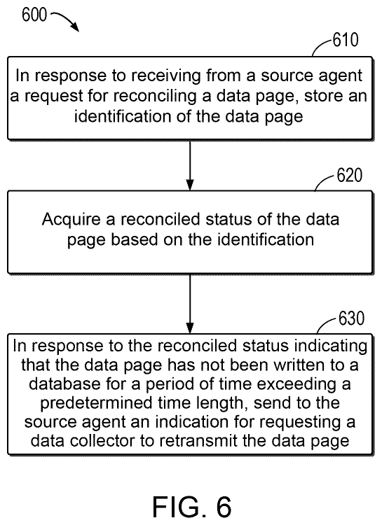

FIG. 6 is a flowchart of a method 600 for confirming a data status according to some embodiments of the present disclosure. The method 600 is typically performed in the data status manager. It should be noted that the method 600 and the foregoing process 400 are complementary, and relevant parts are not repeated.

As shown in FIG. 6, at a block 610, an identification of a data page is stored in response to receiving from a source agent a request for reconciling the data page. In some embodiments, the request may include the identification of the data page and a data collection time, and the identification includes at least one of the following: a data collector identification, a data page identification, a resource type, or a digital fingerprint generated based on the data page.

At a block 620, a reconciled status of the data page is acquired based on the identification. The reconciled status is used to confirm whether the data page transmitted in an OTel Log Format has been written to the database.

Based on the data page identification, the data collection time, and the digital fingerprint, the data status manager sends to a destination agent an indication for confirming whether the data page has been written to the database. Then, the destination agent queries a data page in a nearby database and generates a digital fingerprint of the found data page. By determining whether the two digital fingerprints are consistent, the destination agent determines whether the data page has been written to the database, and returns the determination result (i.e., the reconciled status) to the data status manager.

In response to an indication received from the destination agent of confirming that the data page has not been written to the database, the data status manager needs to further determine whether a time period between the current time and the data collection time is greater than a predetermined time length, and acquire a reconciled status of “retransmission required” when the time period is greater than the predetermined time length.

In response to an indication of confirming that the data page has been written to a database received from the destination agent, the acquired reconciled status is “reconciled.” At the same time, it is determined that the current time is the data reconcile time of the data page.

At a block 630, in response to the reconciled status indicating that the data page has not been written to the database for a period of time exceeding a predetermined time length, an indication for requesting a data collector to retransmit the data page is sent to the source agent.

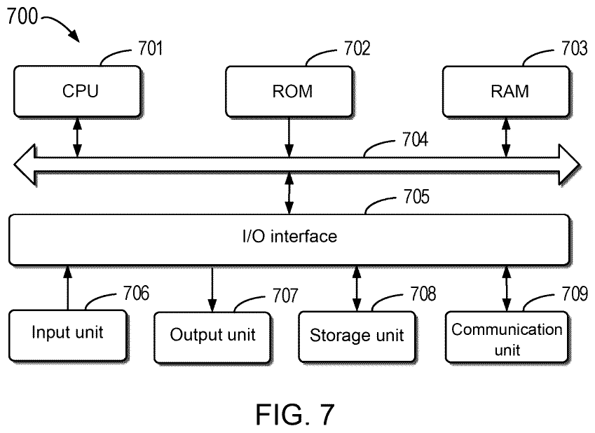

FIG. 7 is a schematic block diagram of example device 700 that can be used to implement an embodiment of the present disclosure. As shown in the figure, the device 700 includes a computing unit 701, which may perform various appropriate actions and processing according to computer program instructions stored in a read-only memory (ROM) 702 or computer program instructions loaded from a storage unit 708 to a random access memory (RAM) 703. In the RAM 703, various programs and data required for the operation of the device 700 may also be stored. The computing unit 701, the ROM 702, and the RAM 703 are connected to each other through a bus 704. An input/output (I/O) interface 705 is also connected to the bus 704.

A plurality of components of the device 700 are connected to the I/O interface 705, including: an input unit 706 such as a keyboard and a mouse; an output unit 707, such as various types of displays and speakers; the storage unit 708, such as a magnetic disk and an optical disc; and a communication unit 709, such as a network card, a modem, and a wireless communication transceiver. The communication unit 709 allows the device 700 to exchange information/data with other devices via a computer network such as the Internet and/or various telecommunication networks.

The computing unit 701 may be various general-purpose and/or special-purpose processing components with processing and computing powers. Some examples of the computing unit 701 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, and the like. The computing unit 701 performs various methods and processes described above, such as the method 300. For example, in some embodiments, the method 300 may be implemented as a computer software program that is tangibly included in a machine-readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 600 described above may be performed. Alternatively, in other embodiments, the computing unit 701 may be configured to perform the method 300 in any other suitable manners (such as by means of firmware).

The functions described hereinabove can be performed at least in part by one or more hardware logic components. For example, non-restrictively, demonstration types of hardware logic components that can be used include Field Programmable Gate Arrays (FPGAs), Application Specific Integrated Circuits (ASICs), Application Specific Standard Products (ASSPs), Systems On Chip (SOC), Load Programmable Logic Devices (CPLDs), etc.

Program codes for implementing the method of the present disclosure may be written by using one programming language or any combination of multiple programming languages. The program codes may be provided to a processor or controller of a general purpose computer, a special purpose computer, or another programmable data processing apparatus, such that the program codes, when executed by the processor or controller, cause the functions/operations specified in the flow charts and/or block diagrams to be implemented. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for confirming a data status, comprising:
in response to receiving from a source agent a request for reconciling a data page, storing an identification of the data page, the identification comprising a data collector identification;
acquiring a reconciled status of the data page based on the identification of the data page, wherein the reconciled status is used to confirm whether the data page transmitted in an OTel Log Format has been written to a database;
determining, by a processing device, a predetermined time length of the data page based on a scale factor and a specific numerical point of a plurality of history reconcile time lengths, the plurality of history reconcile time lengths determined based on a plurality of data collection times and a plurality of data reconcile times associated with the data collector identification; and
in response to the reconciled status indicating that the data page has not been written to the database for a period of time exceeding the predetermined time length, sending to the source agent an indication for requesting a data collector to retransmit the data page.

2. The method according to claim 1, wherein the request comprises the identification of the data page and a data collection time, and the identification comprises at least one of the following: a data collector identification, a data page identification, a resource type, or a first digital fingerprint generated based on the data page.

3. The method according to claim 2, wherein the acquiring a reconciled status of the data page based on the identification comprises:
sending, based on the data page identification, the data collection time and the first digital fingerprint, to a destination agent a request for confirming whether the data page has been written to the database;
determining, based on a confirmation received from the destination agent and indicating that the data page has not been written to the database, whether a time period between a current time and the data collection time is greater than the predetermined time length; and
in response to determining that the time period is greater than the predetermined time length, determining that the reconciled status is that the data page has not been written to the database for a period of time exceeding the predetermined time length.

4. The method according to claim 3, wherein the determining whether a time period between a current time and the data collection time is greater than the predetermined time length comprises:
determining the predetermined time length of the data page based on the identification; and
determining whether the time period between the current time and the data collection time is greater than the predetermined time length.

5. The method according to claim 4, further comprising:
acquiring the plurality of the data collection times and the plurality of data reconcile times in a recent period of time associated with the data collector identification;
determining the plurality of history reconcile time lengths based on the plurality of data collection times and the plurality of data reconcile times; and
determining the scale factor based on the resource type of the data page.

6. The method according to claim 2, wherein the acquiring a reconciled status of the data page based on the identification comprises:
sending, based on the data page identification, the data collection time, and the first digital fingerprint, to a destination agent a request for confirming whether the data page has been written to the database; and
determining, based on a confirmation received from the destination agent and indicating that the data page has been written to the database, that the reconciled status is that the data page has been written to the database.

7. The method according to claim 1, further comprising:
in response to the reconciled status indicating that the data page has been written to the database, sending to the source agent an indication of deleting the data page.

8. The method according to claim 1, further comprising:
in response to the reconciled status indicating that the data page has been written to the database, determining a current time as the data reconcile time of the data page.

9. An electronic device, comprising:
at least one processor; and
a memory coupled to the at least one processor and having instructions stored therein, wherein the instructions, when executed by the at least one processor, cause the device to:
in response to receipt from a source agent of a request for reconciling a data page, store an identification of the data page, the identification comprising a data collector identification;
acquire a reconciled status of the data page based on the identification of the data page, wherein the reconciled status is used to confirm whether the data page transmitted in an OTel Log Format has been written to a database;
determine a predetermined time length of the data page based on a scale factor and a specific numerical point of a plurality of history reconcile time lengths, the plurality of history reconcile time lengths determined based on a plurality of data collection times and a plurality of data reconcile times associated with the data collector identification; and
in response to the reconciled status indicating that the data page has not been written to the database for a period of time exceeding the predetermined time length, send to the source agent an indication for requesting a data collector to retransmit the data page.

10. The device according to claim 9, wherein the request comprises the identification of the data page and a data collection time, and the identification comprises at least one of the following: the data collector identification, a data page identification, a resource type, or a first digital fingerprint generated based on the data page.

11. The device according to claim 10, wherein to acquire the reconciled status of the data page based on the identification the device is caused to:
send, based on the data page identification, the data collection time, and the first digital fingerprint, to a destination agent a request for confirming whether the data page has been written to the database;
determine, based on a confirmation received from the destination agent and indicating that the data page has not been written to the database, whether a time period between a current time and the data collection time is greater than the predetermined time length; and
in response to determination that the time period is greater than the predetermined time length, determine that the reconciled status is that the data page has not been written to the database for a period of time exceeding the predetermined time length.

12. The device according to claim 11, wherein to determine whether the time period between the current time and the data collection time is greater than the predetermined time length the device is caused to:
determine the predetermined time length of the data page based on the identification; and
determine whether the time period between the current time and the data collection time is greater than the predetermined time length.

13. The device according to claim 12, comprising further instructions that, when executed by the at least one processor, cause the device to:
acquire the plurality of the data collection times and the plurality of data reconcile times in a recent period of time associated with the data collector identification;
determine the plurality of history reconcile time lengths based on the plurality of data collection times and the plurality of data reconcile times;
determine the specific numerical point of the plurality of history reconcile time lengths; and
determine the scale factor based on the resource type of the data page.

14. The device according to claim 10, wherein to acquire a reconciled status of the data page based on the identification the device is caused to:
send, based on the data page identification, the data collection time, and the first digital fingerprint, to a destination agent a request for confirming whether the data page has been written to the database; and
determine, based on a confirmation received from the destination agent and indicating that the data page has been written to the database, that the reconciled status is that the data page has been written to the database.

15. The device according to claim 9, comprising further instructions that, when executed by the at least one processor, cause the device to:
in response to the reconciled status indicating that the data page has been written to the database, send to the source agent an indication of deleting the data page.

16. The device according to claim 9, comprising further instructions that, when executed by the at least one processor, cause the device to:
in response to the reconciled status indicating that the data page has been written to the database, determine a current time as the data reconcile time of the data page.

17. A system for confirming data status, comprising:
one or more memories; and
one or more processors configured to execute instructions stored in the one or more memories to:
collect, at a data collector, a data page from a data source;
send, by a source agent, a request for reconciling a data page, the request comprising a data collector identification;
determine a predetermined time length of the data page based on a scale factor and a specific numerical point of a plurality of history reconcile time lengths, the plurality of history reconcile time lengths determined based on a plurality of data collection times and a plurality of data reconcile times associated with the data collector identification;
in response to a received reconciled status indicating that the data page has not been written to a database for a period of time exceeding the predetermined time length, request the data collector to retransmit the data page; and
a in response to receipt at a data status manager from the source agent of the request for reconciling the data page, store an identification of the data page, acquire the reconciled status of the data page based on the identification of the data page, wherein the reconciled status is used to confirm whether the data page transmitted in an OTel Log Format has been written to the database, and, in response to the reconciled status indicating that the data page has not been written to the database for a period of time exceeding a predetermined time length, send to the source agent an indication for requesting the data collector to retransmit the data page.

18. The system according to claim 17, wherein the one or more processors execute further instructions stored in the one or more memories to store, by the source agent, a data page from the data collector and generate a first digital fingerprint of the data page.

19. The system according to claim 18, wherein the one or more processors execute further instructions stored in the one or more memories to:
acquire, by a destination agent, from the data status manager a request for confirming whether the data page has been written to the database, wherein the request comprises a data page identification, a data collection time, and the first digital fingerprint, and the destination agent is further configured to confirm whether the data page has been written to the database.

20. The system according to claim 19, wherein to confirm whether the data page has been written to the database the one or more processors execute instructions to:
query the data page in the database based on the data page identification and the data collection time to identify a found data page;
generate a second digital fingerprint of the found data page;
in response to the second digital fingerprint being consistent with the first digital fingerprint, confirm that the data page has been written to the database; and
in response to the second digital fingerprint being inconsistent with the first digital fingerprint, confirm that the data page has not been written to the database.
